(19) United States
(12) Patent Application Publication
(10) Pub. No.: US 2005/0066337 A1
(43) Pub. Date: Mar. 24, 2005

(54) Portable operating environment

(76) Inventor: Carmody Quinn, Carrollton, TX (US)

Correspondence Address: GROOVER & HOLMES, BOX 802889, DALLAS, TX, 75380-2889, US

(21) Appl. No.: 10/801,516

(22) Filed: Mar. 16, 2004

Related U.S. Application Data
(60) Provisional application No. 60/504,565, filed on Sep. 18, 2003.
(60) Provisional application No. 60/541,877, filed on Feb. 4, 2004.

(51) Int. Cl. G06F 9/46; G06F 3/00; G06F 13/00

(52) U.S. Cl. 719/321; 719/319; 719/327

(57) ABSTRACT

POE is a suite of programs that enables a user to retain program, data, and environment settings across multiple windows or unix based environments. POE enables a user to take programs, data, environmental and registry settings from a windows or unix environment and utilize them from a remote storage source.

### CROSS-REFERENCE TO RELATED APPLICATIONS

This application claims priority from U.S. Provisional Application 60/504,565 filed on Sep. 18, 2003. This application also claims priority from U.S. Provisional Application 60/541,877 filed on Feb. 4, 2004.

### BACKGROUND AND SUMMARY OF THE INVENTION

This application relates to the Portable Operating Environment (hereafter referred to as POE). POE is a suite of programs that enables a user to retain program, data, and environment settings across multiple windows or unix based environments.

POE enables a user to take programs, data, environmental and registry settings from a windows or unix environment and utilize them from a remote storage source.

The user is assumed to have installed programs on their default windows or unix machine as well as data and any configuration or default settings and alterations they so desire. FIG. 1 illustrates how the user may then use POE in order to:

Store settings, programs, and data to a remote or portable drive.

Create an instance of the user's stored environment on a local windows machine.

Remove an instance of the user's stored environment and restore to previous registry settings and environment.

### BRIEF DESCRIPTION OF THE DRAWINGS

FIG. 1 is an illustration of the POE functional layout.

FIG. 2 is a flowchart of the POE configuration and setup.

FIG. 3 is a flowchart of the POE Environment Capture.

FIG. 4 is a flowchart of the POE Invoke Environment.

FIG. 5 is an illustration of the system registry before invoking POE environment.

FIG. 6 is an illustration of the system registry after invoking POE environment.

FIG. 7 is an illustration of the POE Restore Environment.

FIG. 8 is an illustration of the potential use of POE.

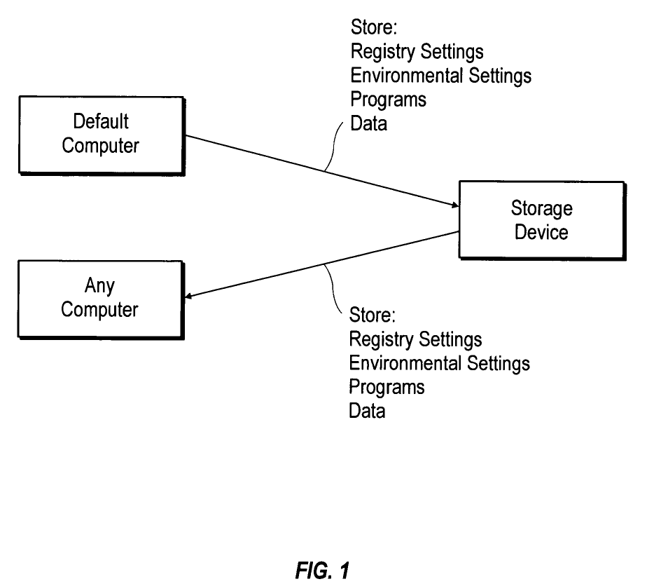

### DETAILED DESCRIPTION OF THE PREFERRED EMBODIMENTS

POE Configuration and Setup

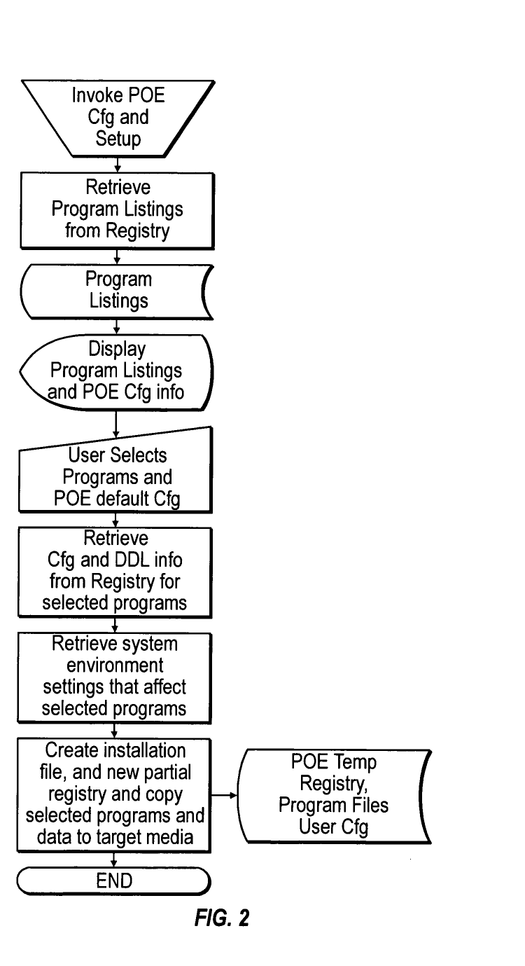

The POE configuration and setup is illustrated as a flowchart in FIG. 2. The user installs the POE software and invokes the POE configuration utility. The POE configuration utility allows the user to select programs to copy over to a removable or remote storage location.

In the POE configuration utility, the preferred selection method is somewhat similar to the “Add/Remove Program” selection in Windows: the user simply selects an installed programs, and the POE configuration utility then looks up (using installation and registry information) which files to move or copy. The files needed can include programs, DLLs, and/or configuration or program data information. POE will either move or make a copy of these programs and the related registry and environmental settings to the desired location as well as the POE suite of programs.

The copy or move method is ordinary and can optionally include a zip or tar technology to minimize size of programs before move or copy. Where a single data module or location is regularly used for POE, the copy process can optionally be shortened to a mere updating process.

Optionally, the user can take control of program installation at the target location and simply use POE to store and retrieve registry settings.

Normally, the user is expected to copy his/her own data over to the target location. Alternatively, the POE software can be configured so that the user has the option for POE to search out all files on the machine of the corresponding file types to the selected programs and automatically (after providing a list for user selection) move or copy to the target location. Removable storage media can be, for example, a flash memory module (e.g. with USB, PCMCIA, CompactFlash, or memory stick connector configuration). Other removable media can optionally include a Zip drive (or other removable disk) or a multimedia disk (e.g. R/W DVDROM). Remote storage can be, for example, a network drive, a remote SAN network drive, an Internet location, or any type of storage media.

POE Environment Capture

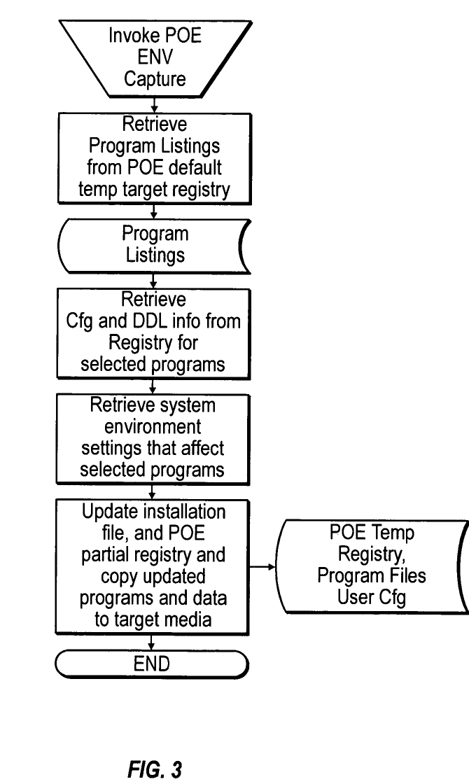

The POE Environment Capture is illustrated as a flowchart in FIG. 3. The user can use the POE Environment Capture to capture all registry settings pertaining to their desired suite of programs and data on the targeted storage media. This allows the user to capture, update, or remove registry settings pertaining to all programs on one or more storage medias that the user has selected.

All registry information will be copied to the target location.

POE Invoke Environment

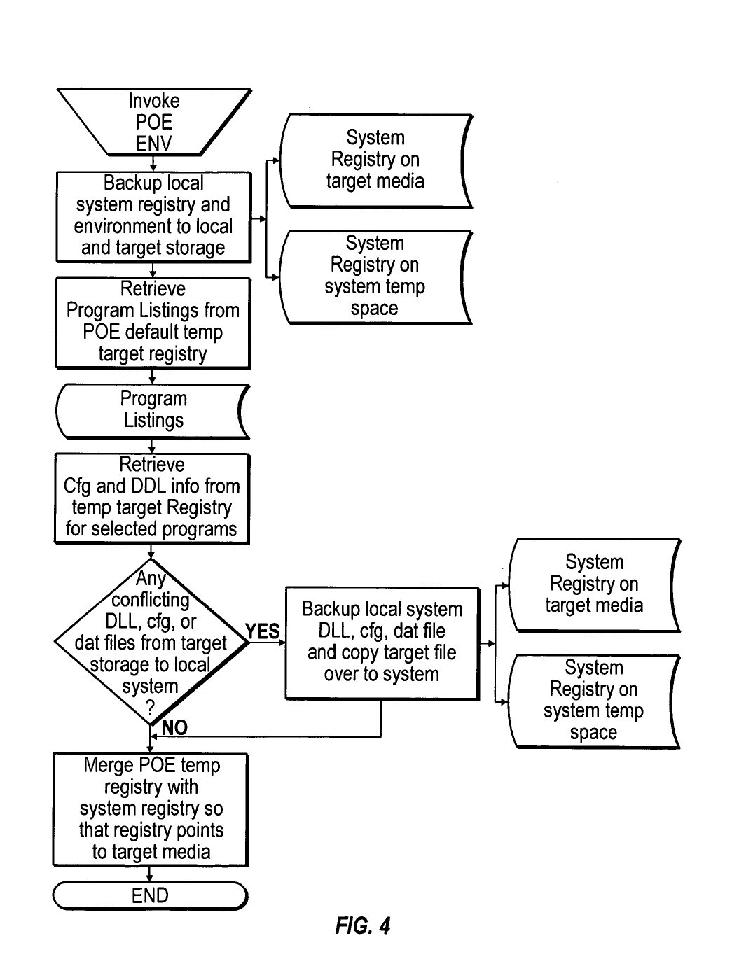

The POE Invoke Environment is illustrated as a flowchart in FIG. 4. When the user selects to invoke the POE environment, they must have access to their POE captured environment, programs and data identified in the captured environment, and the POE suite of programs. When invoked with the appropriate information, POE will backup the local registry, environment, and applicable DLLs on local disk machine disk in temporary storage space and on the targeted media, update the local system registry and environment to point to the programs and data on the targeted media. The targeted programs will not need to be copied locally. This method assumes that the connectivity to the targeted drive is high speed (a high speed network connection, a high speed USB connection or some method that allows relatively high speed loading of programs and DLLs).

At this point, the user may now use the system as they would on their default machine, and they will have access to all of their programs and data on their targeted media. POE's update of the system registry and environment will ensure that the user has their own versions of software, data, and configuration.

Registry updates, program updates, or environmental updates made while on the local machine will be captured to the stored environment on the targeted remote storage media.

POE Invoke Environment can use any of the following methods to create the environment for the user:

1. Merge user specific registry information and environmental information into the local registry.

2. Create a new user with user specific registry information and environmental information in local system and registry.

3. For dynamic use, allow hotkey toggling between registry and environments between user specific and local user information (which can allow multiple program suites and versions to run simultaneously—DLL version conflicts can exist with this method).

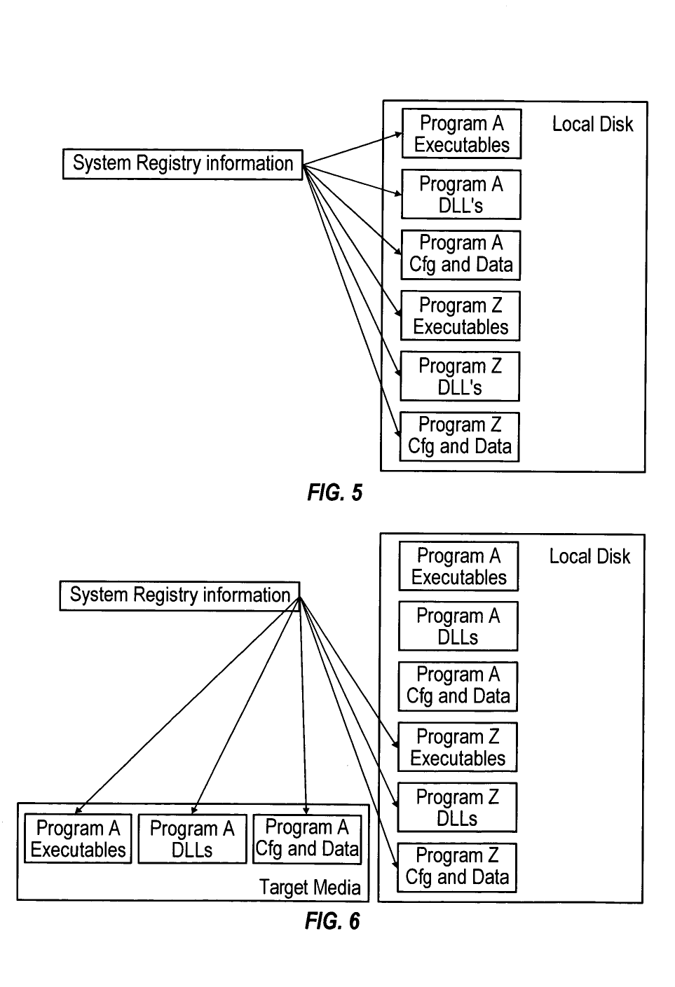

FIGS. 5 and 6 depict an example of the system registry before and after invoking the POE environment. This example assumes that a local system has programs A and Z installed on the system, and that the POE user has program A installed on their target media with the POE environment. This shows how POE alters the registry to point to the user's target programs during a POE invoked environment.

POE Environment Restoration

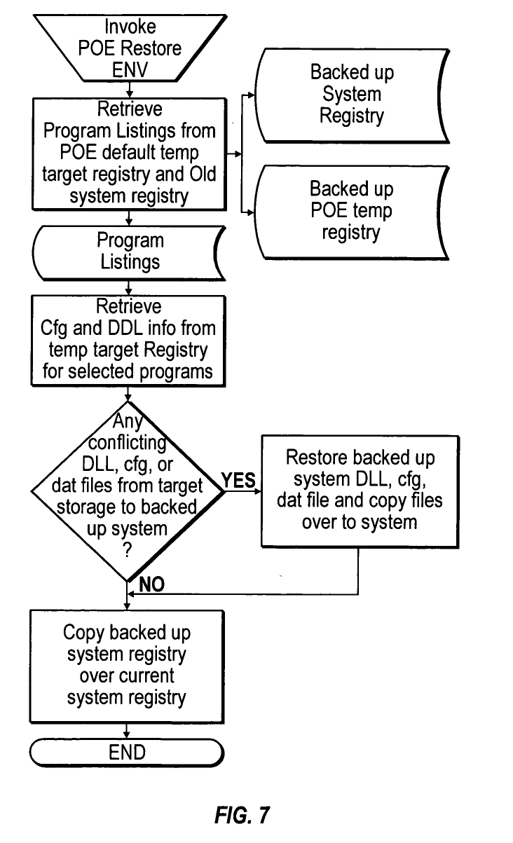

The POE Restore Environment is illustrated as a flowchart in FIG. 7. When POE Environment Restoration is invoked (automatically when target drive can no longer be detected or invoked by user before leaving local machine), it will restore the local machine's registry to the settings stored by POE Invoke Environment. This will restore DLLs, registry settings, and environment and will clean up temporary files that were created while on the local machine.

Technical Limitations

Device drivers and hardware dependent software will not necessarily work across multiple machine environments.

Potential Media Supported

The targeted remote media can be any of the following (but is not limited by hardware type):
USS storage device
Network drive
SAN storage drive.
   Potential Uses

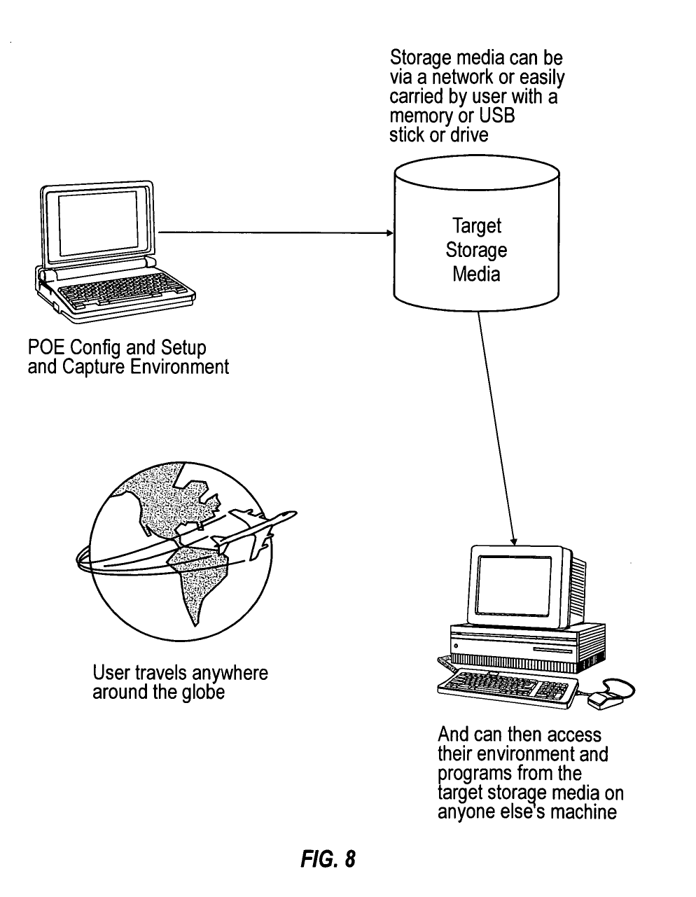

FIG. 8 illustrates the potential use of POE. POE may be used (but is not limited to) the following example uses:

1. A user may use POE to backup all programs and data from their home or main office machine onto a USB stick or USB drive. They may then travel across the world or to any desired location and sit down on another user's machine and pull up their data and programs without worry about version conflicts.

2. A company can use POE to ensure that users do not permanently alter local computer configurations by totally isolating user programs and data to a separate location.

3. A company may also use POE to ensure that a user's program and data are controlled, up to date, and version controlled by controlling the user registry and program version with the POE configuration and setup program.

4. A user may be able to travel worldwide and reach their data across a network from any machine in the world. This would allow them to walk into any cyber café and reach their programs and data anywhere in the world.

5. A user can count on using their programs and data on a system without a network connection by keeping all programs and data on a portable storage media device.

Terminology

DDL: Dynamic Link Library

POE: Portable Operating Environment

1. A method of transporting a customized user interface environment, based on an operating system which permits customization of user interface environments but which does not itself directly provide for machine-independent invocation of a customized environment, comprising the actions of, at various times:
a) operating a utility on a first computer to store customized program-specific settings;
b) operating a second utility on a second computer to reconfigure said second computer to use said settings; and thereafter
c) operating said second computer in accordance with said settings.

2. The method of claim 1, wherein said step a) stores said settings onto a portable data medium.

3. The method of claim 1, wherein said step a) also stores environmental settings.

4. The method of claim 1, wherein said step a) stores registry entries.

5. The method of claim 1, wherein said step b) retrieves said settings from a portable data medium for use.

6. The method of claim 1, wherein said step b) checks for possible conflicts before reconfiguring said second computer.

7. The method of claim 1, wherein said step a) stores said program-specific settings for only some of the programs on said first computer, as manually selected in an operation which does not involve manual installation of programs.

8. The method of claim 1, further comprising the subsequent step of again reconfiguring said second computer, after said step c), to at least partially reverse said step b).

9. The method of claim 1, further comprising the subsequent step of again reconfiguring said second computer, after said step c), to wholly reverse said step b).

10. The method of claim 1, further comprising the subsequent step, after said step c), of automatically erasing all temporary files created on said second computer during said step b).

11. The method of claim 1, further comprising the steps of saving any configuration changes made during said steps b) or c), and synchronizing said configuration changes onto said first computer.

12. The method of claim 1, wherein said step a) stores defined user variables.

13. The method of claim 1, wherein said step a) stores link library files.

14. The method of claim 1, wherein said step a) stores a record of any version conflicts of DLLs or system services.

15. The method of claim 1, wherein said step a) also automatically captures at least some data files which are identifiably associated with programs for which settings are stored in said step a).

16. The method of claim 1, wherein said step b) also automatically identifies program update needs.
